(19) United States
(12) Patent Application Publication
(10) Pub. No.: US 2010/0278099 A1
(43) Pub. Date: Nov. 4, 2010

(54) Methods for Transmitting and Receiving Data and Communication Devices

(75) Inventors: Bu Sung Lee, Singapore (SG); Teck Meng Lim, Singapore (SG); Chai Kiat Yeo, Singapore (SG); Quang Vinh Le, Singapore (SG)

Correspondence Address: DAVIDSON BERQUIST JACKSON & GOWDEY LLP, 4300 WILSON BLVD., 7TH FLOOR, ARLINGTON, VA, 22203, US

(73) Assignee: Nanyang Technological University, Singapore (SG)

(21) Appl. No.: 12/223,176

(22) PCT Filed: Jan. 26, 2007
(86) PCT No.: PCT/SG2007/000027

§ 371 Date: Jul. 24, 2008

Related U.S. Application Data
(60) Provisional application No. 60/762,115, filed on Jan. 26, 2006.

(51) Int. Cl. H04W 40/00

(52) U.S. Cl. 370/328

(57) ABSTRACT

A method for transmitting data from a first communication device to a second communication device, comprising generating a message, wherein the message comprises data to be sent to the second communication device, a source address and a destination address, associating a first address of the first communication device as the source address for the message, associating a first address of the second communication device as the destination address for the message, determining a second address of the first communication device, determining a second address of the second communication device, replacing the first address of the first communication device with the second address of the first communication device as the source address for the message, replacing the first address of the second communication device with the second address of the second communication device as the destination address for the message, and sending the message.

The present application claims the benefit of U.S. provisional application 60/762,115 (filed on 26 Jan., 2006), the entire contents of which are incorporated herein by reference for all purposes.

### FIELD OF THE INVENTION

The present invention refers to methods for transmitting data from a first communication device to a second communication device, and vice versa, to methods for receiving data sent from a first communication device to a second communication device, and vice versa, and to corresponding communication devices.

### BACKGROUND OF THE INVENTION

The advent of networks and the Internet has changed the world, especially in the way data and information is accessed. Wireless communication technologies further added another aspect to the way data and information is accessed—mobility.

Before wireless communication technologies came along, it is commonly assumed that network addresses are static, and application programs are developed based on this assumption. When wireless communication technologies became prevalent, the assumption that network addresses are static may no longer hold true. As a result, many application programs are not able to handle a situation when the network address is changed, especially real-time application programs. For example, when the network address of a communication device being used in a Voice over Internet Protocol (VoIP) call is changed, the VoIP call will be disconnected.

One approach used to solve this ‘problem’ is by using Mobile Internet Protocol (MIP), or more commonly known as MobileIP.

It should also be noted that MIP provides Internet Protocol (IP) mobility. This means the same IP address allocated to a communication device can be used across all communication networks. In this regard, IP mobility may be considered as true mobility or mobility with an unlimited degree of freedom.

However, MIP has the following disadvantages.

Firstly, in order to support MIP, two entities, namely, the Home Agent (HA) and the Foreign Agent (FA) (if any) must be added. A Foreign Agent is not necessarily required. For example, it is required in the case when a mobile node uses a foreign agent's care-of-address for an IPv4 network. Both the HA and FA may be application programs which must be installed in existing network routers. Alternatively, both the HA and FA may be devices connected to existing network routers, which have the functionalities of the HA and FA respectively. In either case, the HA and FA will take away some computing resources from existing network routers, such as computing time and memory storage, thus reducing the performance of the network routers.

Secondly, in MIP, a communication device has a permanent IP address, and uses a method called IP tunneling to facilitate the transmission of messages (including data) between the HA and the communication device. This means that additional data transmissions are needed in order to support MIP.

In addition, IP tunneling requires an IP encapsulation technique that adds an overhead to the size of messages. Also, the basic access scheme for MIP uses tunneling which introduces forms of non-optimized routing; this means that the data transmissions will take a longer time.

In view of the additional data transmissions required, the increased message sizes and the longer data transmission times, the efficiency of data transmissions in the network decreases with the use of MIP.

Thirdly, the installation of the HA and FA entities to existing network routers in order to support MIP requires a significant investment of both time and money.

Another approach to solve this ‘problem’ is by using Session Initiation Protocol (SIP). However, this approach has the following disadvantages.

Firstly, unlike MIP which allows true mobility, SIP only allows a limited mobility, i.e., SIP allows the communication device to move from one communication network to another, but not to retain the same IP address.

In addition, SIP allows limited mobility only for User Datagram Protocol (UDP), but not Transmission Control Protocol (TCP). This is because TCP is a connection oriented protocol, and TCP connections will be disconnected when a change of IP address is detected.

On the other hand, UDP is a connectionless protocol where data packets (or messages) are transmitted and delivered on a best effort basis. If data packets are lost, undelivered or transmitted to, an IP address which is no longer valid (for example, when a communication device has moved to another network and has obtained a new IP address), the sending device may be requested to resend the data packets again to the updated IP address, for example. Accordingly, the limited mobility provided by SIP for UDP is not affected by a detected change of IP address.

Secondly, SIP causes more than one IP address update message to be sent to the other communication device (‘called device’) to which a communication device (‘calling device’) is connected, if there exists more than one connection between the ‘calling device’ and the ‘called device’. For example, if the ‘calling device’ has two UDP connections (two sessions) to the ‘called device’, a change in the IP address of the ‘calling device’ will result in the issuance of two IP address update messages to the ‘called device’. Accordingly, when there are many SIP connections, the additional resultant IP address update messages will cause an increase in data traffic.

An alternative approach to solve this ‘problem’ is provided by the method and devices as defined in the respective independent claims of the present application. An advantage of this alternative approach is that it does not require any additional installation of entities, devices or application programs in existing network routers, or in the communication network. Other advantages of this alternative approach include not requiring the assignment of a permanent IP address (unlike MIP), using only one IP address for each network interface of a communication device at any one time (MIP uses two IP addresses for each network interface of a communication device in a foreign network), and not requiring IP tunneling (IP packets are transmitted directly from one communication device to another).

### SUMMARY OF THE INVENTION

In one embodiment of the invention, a method for transmitting data from a first communication device to a second communication device is provided, comprising generating a message, wherein the message comprises data to be transmitted to the second communication device and a destination address, associating a first address of the second communication device as the destination address for the message, determining a second address of second communication device, mapping the first address of the second communication device to the second address of the second communication device as the destination address for the message, and transmitting the message using the second address of the second communication device as the destination address for the message.

In another embodiment of the invention, a method for transmitting data from a first communication device to a second communication device is provided, comprising generating a message, wherein the message comprises data to be transmitted to the second communication device and a source address, associating a first address of the first communication device as the source address for the message, determining a second address of the first communication device, mapping the first address of the first communication device to the second address of the first communication device as the source address for the message, and transmitting the message using the second address of the first communication device as the source address for the message.

The two embodiments described above may also be combined, such that, illustratively, in a data transmission between the two communication devices, two sets of source and destination addresses are kept in each communication device. The first source and destination addresses are fixed reference addresses, which are reflected to higher layer protocols and applications. The second source and destination addresses are the temporary current addresses, which can be changed, for example, when one communication device moves to another network.

For a message being sent by the first communication device, the first address (reference address) of the first communication device being used as the source address of the message may be mapped to the second address (current address) of the first communication device. Also, the first address (reference address) of the second communication device being used as the destination address of the message may be mapped to the second address (current address) of the second communication device. The message is then transmitted with the current addresses as the source and destination addresses.

For example, only the first address of the second communication device is mapped to the second address of the second communication device as the destination address and the first address of the first communication device stays the same if the first communication device has a fixed IP that does not change. This may for example be the case when the first communication device is not a mobile device with a fixed IP, for example a server computer or a personal computer with a fixed IP. Similarly, only the source address is changed, i.e., only the first address of the first communication device is mapped to the second address of the first communication device and the destination address is not changed, if the second communication device has a fixed IP and the first communication device has an IP that may change.

According to another embodiment of the invention, a method for receiving data transmitted from a first communication device to a second communication device is provided, comprising receiving a message, wherein the message comprises data to be transmitted to the second communication device and a first address of the second communication device as destination address, determining a second address of the second communication device, mapping the first address of the second communication device to the second address of the second communication device as the destination address for the message.

According to another embodiment of the invention, a method for receiving data transmitted from a first communication device to a second communication device is provided, comprising receiving a message, wherein the message comprises data to be transmitted to the second communication device and a first address of the first communication device as source address, determining a second address of the first communication device, and mapping the first address of the first communication device to the second address of the first communication device as the source address for the message.

According to further embodiments of the invention, communication devices according to the methods described above are provided.

The embodiments which are described in the context of one of the methods for transmitting data from a first communication device to a second communication device are analogously valid for the other method for transmitting data from a first communication device to a second communication device, the methods for receiving data sent from a first communication device to a second communication device and the communication devices.

As used herein, a communication device may be, but is not limited to, a radio communication device or a terminal communication device. A radio communication device, for example, may be but is not limited to, a mobile radio communication device, or a satellite radio communication device. For example, a communication device may be, but is not limited to, a mobile phone, a personal digital assistant or a portable computer.

Also, as defined and used herein, a message refers to a data item being sent a communication endpoint, where the data item is arranged according to a pre-determined format, and is used for pre-determined communication functions in a network. A message comprises data, a source address and a destination address. The message data may be, but is not limited to, application data or control data. There may be various address information included in the message, for example an IP address or network port identification.

As used herein, an address refers to the coded representation of the source or the destination of a message.

For example, the first address of the first communication device, the second address of the first communication device, the first address of the second communication device and the second address of the second communication device may be addresses of the same protocol layer. In another embodiment, the first address of the first communication device, the second address of the first communication device, the first address of the second communication device and the second address of the second communication device may be network layer addresses. In still another embodiment, the first address of the first communication device, the second address of the first communication device, the first address of the second communication device and the second address of the second communication device are Internet Protocol addresses.

Embodiments of the invention emerge from the dependent claims.

According to one embodiment of the invention, determining the second address of the first communication device further comprises determining the second address of the first communication device from a communication network, to which the first communication device is connected, storing the second address of the first communication device determined on the first communication device, and registering the second address of the first communication device determined with a network agent device, wherein the network agent device is capable of storing the second address and providing the second address of the first communication device to any communication device which requests for the second address of the first communication device.

In this embodiment, the first communication device determines if it has obtained a new address from the communication network to which it is connected. This may happen, for example, when the first communication device moves from one communication network to another communication network. This may also happen, for example, when the first communication device moves from a first cell of a communication network to a second cell of the same communication network, wherein the first cell of the communication network and the second cell of the communication network are not connected to the same router.

When the first communication device determines if it has indeed obtained a new address from the communication network to which it is connected, it stores the new address determined as its second address. The first communication device also registers its second address with a network agent device.

As defined and used herein, the network agent device refers to a device, to which a communication connection can be established via the communication network, and which is capable of storing the second address and providing the second address of the first communication device to any communication device which requests for the second address of the first communication device.

In this regard, it should be noted that it is not necessary for the network agent device to be in the same communication network as the first communication device. This means any device which is capable of storing the second address and providing the second address of the first communication device to any communication device which requests the second address of the first communication device can be a network agent device. In one embodiment, the network agent device is a Session Initiation Protocol Redirect Server (SIP-RS).

In view of the above, it can be seen that one network agent device in the existing inter-connected communication networks today is sufficient to ensure that this embodiment of the invention can work. However, if there were only one network agent device, this network agent device may encounter the problems related to high traffic volumes. In this regard, the availability of more network agent devices will help distribute or share the high traffic volume.

It is also possible that embodiments of the invention may work without the use of a network agent device in some situations. For example, a communication device may already have the fixed IP address of a File Transfer Protocol (FTP) server. In this example, the FTP server has a fixed IP address and therefore does not need to register its IP address with a network agent device. Additionally, a communication session is always initiated by the communication device. Accordingly, the communication device also does not need to register its IP address with a network agent device, if the communication device only needs to communicate with the FTP server.

According to one embodiment of the invention, determining the second address of the second communication device further comprises determining the second address of the second communication device from an address mapping table stored in the first communication device.

As used herein, the address mapping table refers to a means of arranging data and information related to addresses, as well as the various correspondences and associations.

For example, in one embodiment, the address mapping table further comprises a correspondence of the first address of the second communication device and the second address of the second communication device. In another embodiment, the address mapping table further comprises an index to an information table, wherein the second address of the second communication device is stored in the information table according to the index. In still another embodiment, the address mapping table further comprises the address of the network agent device, with which the second address of the second communication device is registered.

In one embodiment, the mapping is carried out by using an address mapping table. In another embodiment, the address mapping table is stored in the first communication device.

According to one embodiment of the invention, the method provided further comprises sending a communication message to the second communication device using the second address of the second communication device stored in the address mapping table of the first communication device, when it is determined that the second address for the first communication device is a new address.

For example, in this embodiment, the first communication device may determine whether or not its second address is a new address as follows. When the first communication device determines an address from the communication network to which it is connected, it can compare this address determined with its current second address.

If the address determined is the same as the current second address, the second address is considered as not new.

If the address determined is different from the current second address, as explained earlier, the address determined is stored as the second address. Accordingly, the second address is considered as new in this case.

Also, in this embodiment, the objective of sending a communication message to the second communication device is to inform the second communication device of the change in address of the first communication device. In this regard, the communication message here may be any message which comprises the source and the destination addresses.

For example, in one embodiment, the communication message sent is a Session Initiation Protocol (SIP) communication message. In another embodiment, the communication message sent is an Invite message. In still another embodiment, the communication message sent is an Invite message with Binding Update option.

In this regard, an Invite message is used in the SIP protocol, by a first communication device establishing a communication session (or connection) with a second communication device (see for example [1]).

In this conjunction, a binding in the context of the SIP protocol refers to the association between the address of a first communication device and a SIP session with a second communication device. Accordingly, the Binding Update option of the Invite message may be used to update the said association, when the first communication device obtains a new address, for example.

In one embodiment, the method provided further comprises determining the address of the network agent device which has registered the second address of the second communication device, and sending an address request message to the said network agent device using the address of the network agent device determined, to request for the second address of the second communication device, when it is determined that a communication connection to the second communication device could not be established using the existing second address of the second communication device stored in the address mapping table of the first communication device.

For example, the address of a network agent device where the second address of the second communication device is registered is determined, and sending an address request message is sent to the network agent device using the address of the network agent device determined to request the second address of the second communication device. The address request message is for example sent when it is determined that a communication connection to the second communication device could not be established using the first address of the second communication device or a third address of the second communication device stored on the first communication device. The third address is for example an address of the second communication device that was stored on the first communication device because it has previously been valid and has previously been used for communicating with the second communication device. If it is no longer valid and consequently, no communication connection can be established using the third address, the second address of the second communication device which is currently valid is requested from the network agent device.

In this embodiment, when the first communication device determines that a communication connection to the second communication device could not be established using the existing second address of the second communication device stored in the address mapping table of the first communication device, it will do the following.

Firstly, the first communication device determines the address of the network agent device which has registered the second address of the second communication device. For example, in one embodiment, the first communication device can determine the address of the network agent device which has registered the second address of the second communication device, from the address mapping table.

Secondly, the first communication device sends an address request message to the said network agent device using the address of the network agent device determined, to request for the second address of the second communication device. In this regard, a suitable address request message depends primarily on the communication protocol used to communicate with the network agent device. For example, the address request message may be an SIP Invite message.

Also, in this embodiment, the objective of sending an address request message to the said network agent device is to obtain an updated address of the second communication device, in order to be able to establish a communication connection to the second communication device again.

In one embodiment, the first address of the first communication device is mapped to the second address of the first communication device, and the first address of the second communication device is replaced by the second address of the second communication device, in the message, by a unit of the network layer.

In one embodiment, the message is generated such that it comprises the first address of the first communication device and the first address of the second communication device, and the first address of the first communication device is replaced by the second address of the first communication device, and the first address of the second communication device is mapped to the second address of the second communication device, in the message.

In this embodiment, at the point when the message is generated, it comprises the first address of the first communication device as its source address and the first address of the second communication device as its destination address. In a subsequent processing of the message generated, the first address of the first communication device is mapped to the second address of the first communication device, and the first address of the second communication device is mapped to the second address of the second communication device, in the message. Accordingly, in this processed message, the source address is now the second address of the first communication device and the destination address is now the second address of the second communication device.

In one embodiment, the first address of the first communication device is replaced by the second address of the first communication device, and the first address of the second communication device is mapped to the second address of the second communication device by deleting the first address of the first communication device from the message and inserting the second address of the first communication device into the message, and by deleting the first address of the second communication device from the message and inserting the second address of the second communication device into the message.

As explained earlier, the first communication device may obtain a new address from the communication network to which it is connected, when it moves from one communication network to another communication network. Therefore, if the first communication device is stationary when it is switched on, the first communication device obtains only one address from the communication network to which it is connected. In this case, both the first address of the first communication device and the second address of the first communication device have the same value, namely, the only one address obtained from the communication network to which the first communication device is connected. This observation applies to the second communication device as well.

Accordingly, in one embodiment, the first address of the first communication device has the same value as the second address of the first communication device. In another embodiment, the first address of the second communication device has the same value as the second address of the second communication device.

In one embodiment, a method for transmitting data from a first communication device to a second communication device is provided, comprising generating a message, wherein the message comprises data to be transmitted to the second communication device, a source address and a destination address, associating a first address of the first communication device as the source address for the message, associating a first address of the second communication device as the destination address for the message, determining a second address of the first communication device, determining a second address of the second communication device, mapping the first address of the first communication device to the second address of the first communication device as the source address for the message, mapping the first address of the second communication device to the second address of the second communication device as the destination address for the message, and transmitting the message using the second address of the first communication device as the source address and the second address of the second communication device as the destination address for the message.

In one embodiment, the message is encapsulated to generate an encapsulated message comprising the message by adding a header to the message comprising the first address of the second communication device as destination address for the encapsulated message. The first address of the second communication device is mapped to the second address of the second communication device as destination address for the encapsulated message in the header. Illustratively, after the address swapping is carried out in the message, the message is encapsulated (for example according to IPsec) and a second address swapping is carried out in the header which was added to the message when encapsulating the message. This can be done with source addresses as well as with destination addresses. When such an encapsulated message is received, the addresses are swapped back in the header of the encapsulated message, the message is restored from the encapsulated message and the addresses in the message are swapped back.

The second address of the first communication device (and similarly, as mentioned above, the second address of the second communication device) may be stored on a network agent device. For example, the first communication device may request, by sending a registering message comprising the second address of the first communication device to the network agent device, that the second address of the first communication device be stored on the network agent device and be for example provided to any communication device requesting the second address of the first communication device. The second address of the first communication device may also be pre-stored on the network agent device, for example by an authorized agent such as a network administrator. The second address of the second communication device may be stored on a network agent device analogously.

Embodiments of the invention have the following advantages.

Firstly, from the embodiments of the invention described above, it can be seen that the invention allows seamless communication when communication devices move across different networks. Also, active Internet applications which are using the invention wilt be able to continue its communication seamlessly when communication devices move. For example, the invention enables Voice over IP (VoIP) phones to be used seamlessly across Wireless Local Area Networks (WLANs).

By replacing the destination address and/or the source address in the message it is possible to keep a TCP connection even if the IP address of the first communication device and/or the second communication device changes. It is not necessary to tear down a TCP connection and establish a new one if the IP address of the first communication device and/or the second communication device changes.

Additionally, this is possible without using techniques like IP tunneling and thus without using a lot of overhead. The replacement of the destination address and/or the source address in the message can be done without the requirement of much computing power and introduces only little overhead and latency.

Secondly, it can be seen that the invention requires little or no infrastructure equipment expenditure in order to support its implementation. Any existing suitable network agent device may be used. Even in a worst case scenario, where no suitable network agent devices are available, the invention can be supported by additionally connecting one network agent device to any network. Therefore, the invention is an inexpensive and easy to implement solution to the said ‘problem’.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication system according to an embodiment of the invention.

FIG. 2 shows an illustration of one embodiment of the invention.

FIG. 3 shows a protocol layer diagram indicating where the method provided by the invention is located, according to an embodiment of the invention.

FIG. 4 shows an illustration of one embodiment of the invention, wherein an application which is compatible with the invention is executed on a communication device which is compatible with the invention.

FIG. 5 shows an illustration of one embodiment of the invention, wherein an application which is not compatible with the invention is executed on a communication device which is compatible with the invention.

FIG. 6 shows an exchange of messages when the second communication device receives a new address according to one embodiment of the invention.

FIG. 7 shows another exchange of messages when the first communication device receives a new address according to one embodiment of the invention.

FIG. 8 shows examples of messages used in one embodiment of the invention.

### DETAILED DESCRIPTION OF THE INVENTION

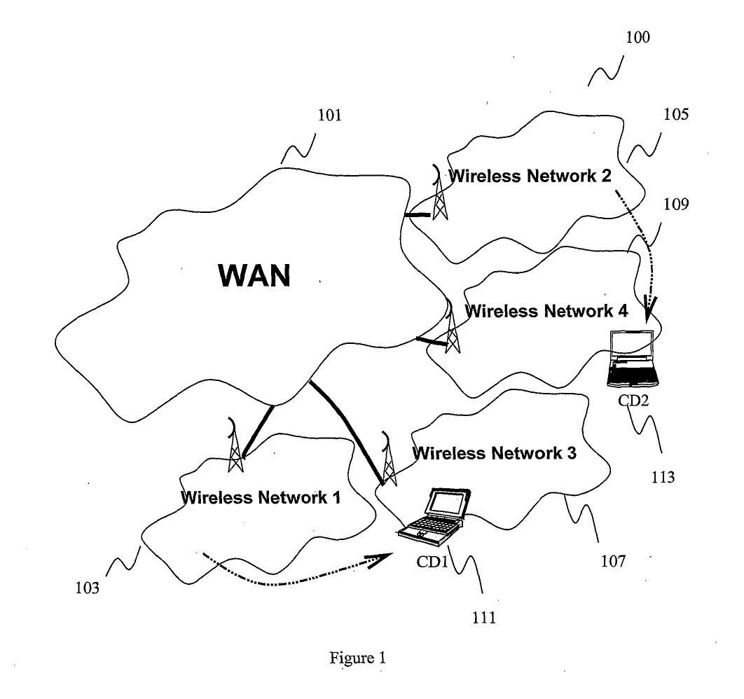

FIG. 1 shows a communication system 100 according to an embodiment of the invention.

The communication system 100 comprises a wide area network 101, a first wireless network 103 (denoted by wireless network 1), a second wireless network 105 (denoted by wireless network 2), a third wireless network 107 (denoted by wireless network 3), a fourth wireless network 109 (denoted by wireless network 4), a first communication device 111 (denoted by CD1) and a second communication device 113 (denoted by CD2).

Communication device CD1 111 has a communication connection with communication device CD2 113. This communication connection is maintained even though communication device CD1 111 moves from wireless network 1 103 to wireless network 3 107, and communication device CD2 113 moves from wireless network 2 105 to wireless network 4 109.

The wide area network 101 in FIG. 1 is for example the Internet connecting various local area networks. Examples of wide area networks include HDLC, ISDN, X.25 Frame-Relay and ATM. Examples of local area networks include Ethernet, FDDI, FDDI2, WLAN, WiMAX, Hiperlan, UMTS, GSM, CDMA2000 and 3G, 4G and beyond.

The communication devices CD1 (111) and CD2 (113) respectively is a radio communication device, a terminal communication device, a mobile radio communication device, or a satellite radio communication device. As shown in FIG. 1, for example, the communication devices CD1 and CD2 respectively may also be a notebook PC with suitably equipped wireless network card or module.

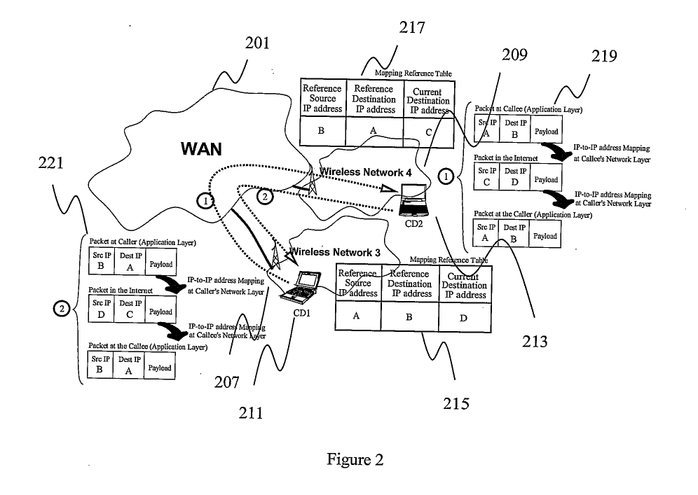

FIG. 2 shows an illustration of one embodiment of the invention.

As subsequent description are given using diagrams, which are similar to FIG. 1, the labeling of items within the figures will be kept consistent. In this regard, the following items in FIG. 2 have been labeled as follows: wide area network 201, wireless network 3 207, wireless network 4 209, communication device CD1 211 and communication device CD2 213.

Thus far, the term address is used in the general sense. However, from this point onwards, this embodiment as well as other embodiments of the invention will now be described using IP address as a specific example of address.

In this illustration, communication device CD1 211 and communication device CD2 are connected via a communication connection, wherein communication device CD1 211 is considered as the ‘caller’ (calling device) and communication device CD2 213 is considered as the ‘callee’ (called device).

From the address mapping table (also called mapping reference table) for communication device CD1 (215), the first address (reference destination IP address) and the second address (current destination IP address) for communication device CD2 213 are respectively B and D. Similarly, from the address mapping table for communication device CD2 (217), the first address (reference destination IP address) and the second address (current destination IP address) for communication device CD1 211 are respectively A and C.

In a message transmission from communication device CD1 211 to communication device CD2 213, the address swapping carried out on the message transmitted is shown in the box labeled 219.

As used herein, address swapping refers to the process of replacing the first addresses (the reference source and destination addresses) with the corresponding second addresses (current source and destination addresses). The address swapping is carried out using the information stored in the address mapping table of the respective communication device.

At the application level (or application layer level), the message generated by the application has the first address of communication device CD1 211 as its source address and the first address of communication device CD2 213 as its destination address (line 1 of box 219).

As a side remark, it should be noted that addresses are used ‘directly’ at the network layer for functions such as routing, for example. As such, addresses are not used ‘directly’ at the application layer. However, in an example where an application on a first communication device is in communication with another application on a second communication device, the respective applications typically uses addresses as a means to identify one another. In this regard, addresses are used ‘indirectly’ at the application layer.

After the address swapping is carried out, the message (at the Internet level) has the second address of communication device CD1 211 as its source address and the second address of communication device CD2 213 as its destination address (line 2 of box 219).

The address swapping is carried out again at the receiving side (i.e., communication device CD2 213), and the message reaches the application layer of communication device CD2 213 again with the first address of communication device CD1 211 as its source address and the first address of communication device CD2 213 as its destination address (line 3 of box 219).

Similarly, the effect of address swapping on the message can also be seen in box 221 with the second message transmission of FIG. 2, i.e., from communication device CD2 213 to communication device CD1 211. In this regard, the direction of the message is reversed. The address swapping is carried out in the same way, except that now communication device CD2 213 is the source of the message and communication device CD1 211 is the destination of the message.

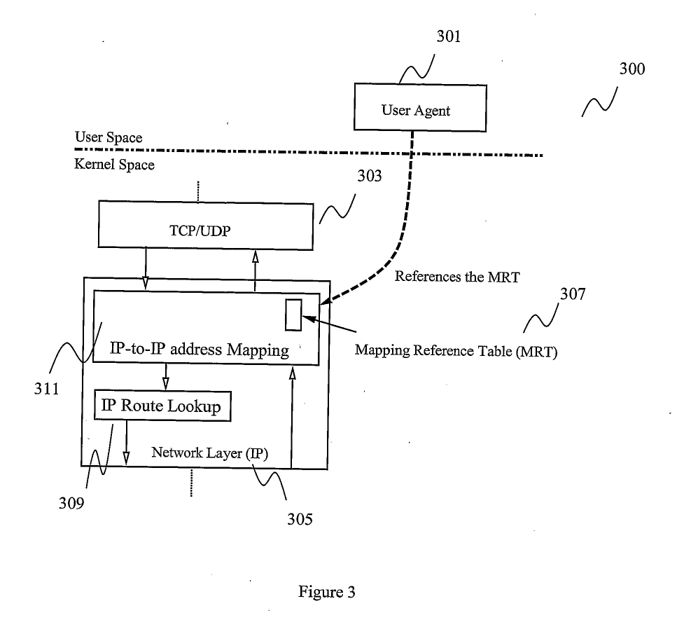

FIG. 3 shows a protocol layer diagram 300 indicating where the method provided by the invention is located, according to an embodiment of the invention.

In this embodiment, the method provided by the invention is implemented as a user agent 301. As shown in FIG. 3, the user agent 301 is located in the user space.

As explained earlier, the address swapping is performed using the information stored in the address mapping table (also called mapping reference table) 307. This table is maintained by the user agent 301, which updates this table whenever it receives new Invite message with Binding Update option.

It can be seen from FIG. 3 that address swapping is performed on downstream (outgoing) messages (by the IP-to-IP address mapping module 309) before they are passed to the IP route lookup module 311. In the reverse direction, address swapping is performed on upstream (incoming) messages before they are passed to the Transport layer (TCP or UDP layer) 303.

Next, address swapping is described in more detail as follows.

In order to ensure IP address transparency when the IP addresses of the two communication devices in a session or connection changes, an IP-to-IP address mapping is performed at the network layer of the communication devices.

As a side remark, there may also be defined a specific Router Alert in the IP Router Alert Option (RA), as described in [2]. A message may be tagged with a router alert option (for example by a module in the network layer) alerting the destination communication device that a message which requires address swapping has been received.

In an alternative embodiment, the port number in the IP header of a message is used to determine whether the message requires IP address swapping.

Accordingly, when a message with a Router Alert is received by a communication device, the source IP address of the message is replaced with the reference destination IP address (the first address of the second communication device) and the destination IP address of the message is replaced with the reference source IP address (the first address of the first communication device). It should be noted that when the source address and/or the destination address of the message are replaced, the checksum of the message must also be updated.

As shown earlier in FIG. 2, when communication device CD1 211 sends a message to communication device CD2 213, the message generated at the application layer has the source address A, and destination address B, which were the corresponding source and destination addresses at the point when the session started. Since both communication devices have moved, address swapping is performed at the network layer of communication device CD1 211 to change the source address of the message to the current IP address of communication device CD1 211 (the second address of the first communication device) and the destination address of the message to the current destination IP address of communication device CD2 213 (the second address of the second communication device), as stored in the address mapping table. The correction of the destination address ensures that the message will reach the last known address of communication device CD2 213, while the correction of the source IP address makes network ingress filtering unnecessary (see for example [3]).

When the message is received by the communication device CD2 213, another address swapping is performed on the message at the network layer. This address swapping restores the original source and destination addresses (the first addresses) for the message. As shown in FIG. 2, the address swapping at communication device CD2 213 restores the source address of the message to the reference destination address of communication device CD1 211 (the first address of the second communication device) and the destination address of the message to the reference source IP address of communication device CD2 213 (the first address of the first communication device), as stored in its address mapping table.

It should be noted that this address swapping restores the message with the IP addresses at the moment when the session started. Accordingly, this makes the IP address changes on the message transparent to the application, i.e., from the view of the application using the communication session the IP addresses remain the same throughout the whole session.

Thus far, the description given on the invention is for general network agent devices. Subsequent description of the invention would be given for a specific case of network agent devices, namely with the network agent device being the Session Initiation Protocol (SIP) Redirect Server as an example. In this regard, the SIP Redirect Server, which is one of the service types of a SIP server, provides an “IP address directory service” for its registered users.

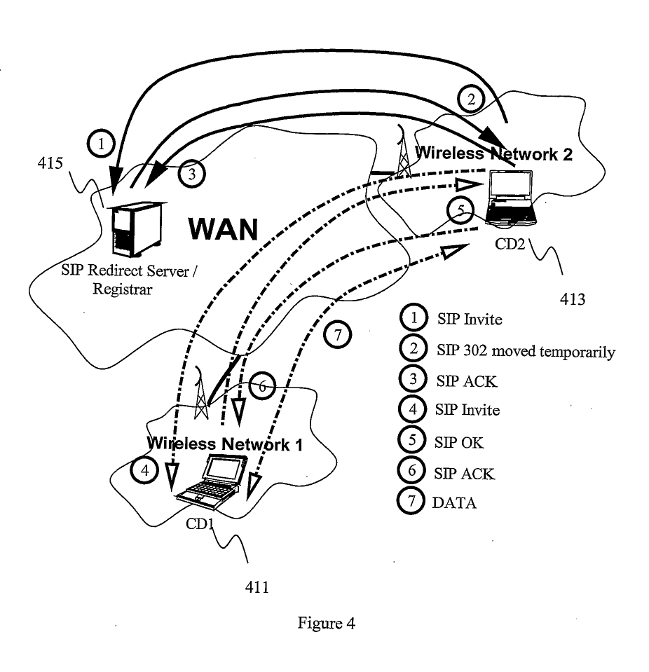

FIG. 4 shows an illustration of one embodiment of the invention, wherein an application which is compatible with the invention is executed on a communication device which is compatible with the invention.

In this illustration, the communication devices CD1 411 and CD2 413 first register their addresses with suitable SIP. Registrars, such as the SIP Redirect Server 415, where their IP addresses are stored.

The communication device CD2 413 becomes the calling device (or caller) and proceeds to establish a session with communication device CD1 411 (called device or callee). The application compatible with the invention in the communication device CD2 413 (caller) sends an Invite message to the SIP Redirect Server 415. This message contains a session description, which includes the SIP URI of communication device CD1 411 (callee).

Next, the SIP Redirect Server 415 resolves the location of the communication device CD1 411 (callee) and sends the IP address of the communication device CD1 411 (callee) to the communication device CD2 413 (caller) using a Moved Temporary message. To implement the resolving of the SIP URI, the conventional gethostbyname function which resolves an URL (uniform resource locator) or a host name into an IP address can for example be modified such that it can also receive SIP URIs as input and determine the corresponding IP addresses. Alternatively, a new family called URI in the socket library can be introduced. In both cases, the SIP Redirect Server 415 resolves the SIP URI to an IP address of the communication device CD1 411.

After that, the communication device CD2 413 (caller) sends an Acknowledgement message to acknowledge the receipt of the Moved Temporary message.

Thereafter, the communication device CD2 413 (caller) sends a new Invite message directly to the communication device CD1 411 (callee). The communication device CD1 411 (callee) replies using an OK message. After that, the communication device CD2 413 (caller) sends an Acknowledgement message to acknowledge the receipt of the OK message.

Once the session setup is completed, data transmission between the communication device CD2 413 (caller) and the communication device CD1 411 (callee) can then begin.

In this embodiment of the invention, an application program compatible with the user agent (of the invention) registers itself directly with the user agent. The registration process may be automated using a modified socket library as mentioned above. If the application program is not compatible with the user agent, an application wrapper can be used to automate the registration process if the gethostbyname function is not used.

The application continues to execute seamlessly after the session establishment is completed, even when there are changes of the IP addresses on both communication devices. At the end of the session, the said application program simply de-registers itself with the user agent, in order to end the session.

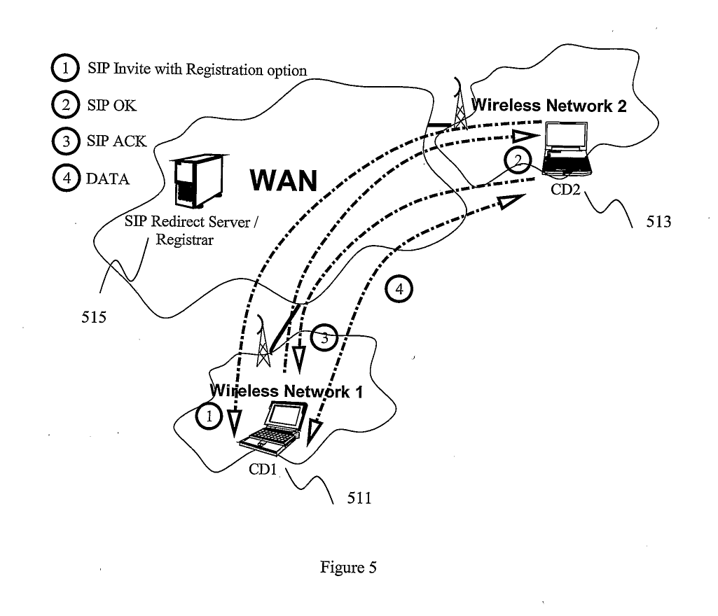

FIG. 5 shows an illustration of one embodiment of the invention, wherein an application which is not compatible with the invention is executed on a communication device which is compatible with the invention.

In this illustration, it should be noted that there are many existing legacy Internet applications which are not compatible with the invention (or the user agent). These non-compatible applications use IP address (or rely on a Domain Name System (DNS) server to resolve IP address) to establish a connection.

In this regard, an application which is not compatible with the user agent simply means that there is no direct communication between the said application and the user agent, and the said application does not use the ‘services’ provided by the user agent.

These non-compatible applications can still be executed on a communication device which is compatible with the invention, as explained below.

When an invitation is made by the non-compatible application from communication device CD2 513 using the Invite message with Registration option, this message is detected by the user agent. Accordingly, this message enables the pre-registration of the source and destination addresses used in the address mapping table indirectly. After the subsequent exchange of SIP messages (OK message, followed by ACK message), an SIP session is established, and data exchange between the two communication devices can then be started.

The user agent does not require a re-establishment of the existing session when the IP addresses of the communication devices change. However, a new session must be established only for a new connection to communication device CD1 511 (callee) after the IP address of communication device CD2 513 (caller) is changed. This scenario applies for all ‘callee’ communication devices which has a fixed IP address or which has a dynamic IP address issued by a server.

In this regard, it should be noted that an application wrapper can be built to automate this process. This application wrapper can then establish the connection or session when necessary before launching the required application.

Next, the user agent (which implements the method provided by the invention) is described in more detail as follows.

When an application registers itself with the user agent, the user agent stores information (such as the destination address of the communication device to which a connection is made, and the port number, for example) in its address mapping table. It is noted that at the point of registration, both the first address and the second address of the communication device to which a connection (or session) is to be established, have the same value, namely the said destination address.

At the same time, the source address is also stored in the address mapping table, namely the current source address. This means that at the point of registration, both the first address and the second address of the communication device also have the same value, namely the current source address.

In one embodiment of the invention, when there is a change in the address of the communication device, the user agent sends an Invite message with Binding Update option to all the addresses in the second address field (current destination address field) of its address mapping table.

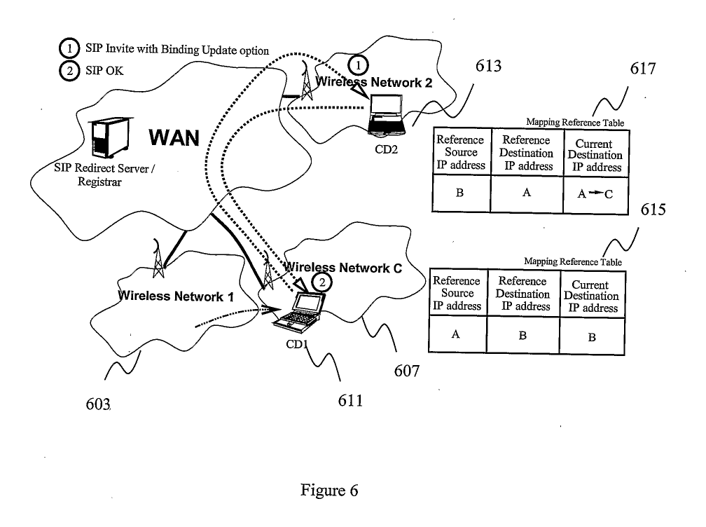

For example, as shown in FIG. 6, when communication device CD1 611 moves from Wireless Network 1 603 to Wireless Network 3 607, its user agent sends an Invite message with Binding Update option to all communication devices, which still have active sessions with it. In this example, the Invite message with Binding Update option is sent to the communication device CD2 613, using the second address (the current destination address) of communication device CD2 613 stored in the address mapping table.

As shown in FIG. 6, when communication device CD2 613 receives the Invite message with Binding Update option, it updates the second address of communication device CD1 611 (current destination address), from A to C (see box 617).

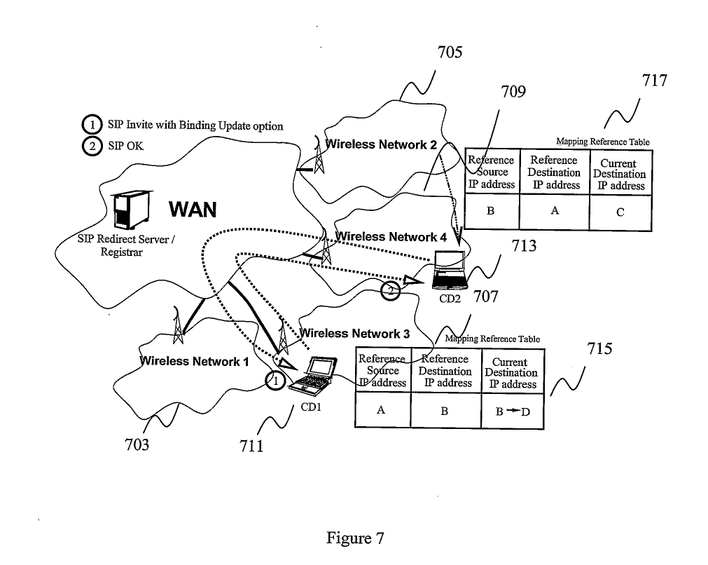

Similarly, as shown in FIG. 7, when communication device CD2 713 moves, an Invite message with Binding Update option is sent to communication device CD1 711. Communication device CD1 711 then updates the second address (current destination address) of communication device CD2 613 in its address mapping table, from B to D, as shown in box 715.

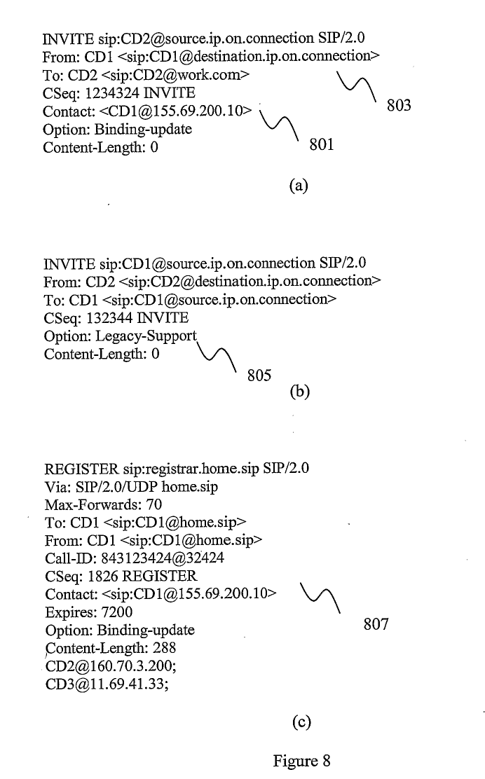

FIG. 8 shows examples of messages used in one embodiment of the invention.

FIG. 8(a) shows an Invite message with Binding Update option. As explained earlier in FIG. 6, when the user agent receives an Invite message with Binding Update option, it updates the second address of the second communication device (the current destination address) with the new destination address specified in the Contact field (item 801) of the Invite message with Binding Update option in the address mapping table, at where the current destination address matches the source address of the Invite message with Binding Update option. In this example, the current destination address (prior to the update) should match the IP address resolved from ‘destination.ip.on.connection’, which is specified in the From field (item 803).

FIG. 8(b) shows an Invite message with Registration option. As explained earlier in FIG. 5, this message is used to support legacy Internet applications. In this regard, the user agent uses an Invite message with Registration option to register for mobility support between two communication devices. As shown in item 805, Legacy-Support is indicated in the Option field of Invite message with Registration option.

As explained earlier in relation to FIG. 6 and FIG. 8(a), a first communication device uses an Invite message with Binding Update option to inform a second communication device of a change in its IP address. It can be seen that if there are n entries in its information table indexed by its address mapping table, the first communication device will use n Invite messages with Binding Update option in order to inform all communication devices, which have established connections or sessions with it.

In order to minimize the amount of Invite messages with Binding Update option generated at the first communication device, the SIP Redirect Server may be extended for server-side binding update support. In this regard, the SIP Redirect Server may be extended to trigger a Binding Update event when it receives an IP address update request via a Register message with Binding Update option, as shown in FIG. 8(c).

The Register message with Binding Update option may contain the following parameters: (i) the new IP address of the requesting communication device in the Contact field (807) and (ii) a list of IP addresses, to which the SIP Redirect Server will send an Invite message with Binding Update option individually.

The first communication device can also re-register its new IP address with its SIP Redirect Server without triggering the server-side Binding Update event by sending the Register message with Binding Update option with zero content, i.e., without the list of IP addresses.

It should be noted that instead of using SIP messages with binding update option or registration option, standard SIP invite and register messages can be used. To register a communication device to a redirect server, a SIP register message may be used. For obtaining an IP address from a redirect server, a SIP invite message may be used. A SIP invite message may also be used for establishing a session.

Next, exemplary application scenarios for the invention are described.

The first application scenario is related to security issues. As secured transactions become more prevalent and important on the Internet, more security related protocols and features will be introduced. Examples of security related protocols and features include firewalls, proxies and IPSec. An embodiment of the invention which is adapted to support IPSec is described as follows.

To support IPSec, additional parameter is stored in the address mapping table, namely, the session identifier (SID) of each session. A session identifier is generated for each session (or connection) and the session identifier is exchanged between communication devices during the signaling process to establish the session.

It is noted that with IPSec, the message is encapsulated with an IPSec header, after address swapping is carried out if necessary to restore the original state of the IP header used by IPsec. The source and destination addresses in the IPSec header are the first addresses, and not the second addresses (current addresses). Accordingly, an additional address swapping needs to be carried out for the source and destination addresses in the IPSec header. In this case, besides replacing the source and destination addresses with the corresponding second addresses (current addresses) in the IPSec header, the session identifier is also tagged onto the IPSec header.

At the receiving side, without a corresponding address swapping, IPSec module will consider the message to be in error due to the modifications made to the IPSec header, and the message will be discarded. However, it is not known at the receiving side which first addresses in the address mapping table is to be used for the message. In this regard, the session identifier is used here to identify the corresponding entry in the address mapping table, in order to be able to obtain the corresponding first addresses to be swapped back into the IPSec header.

After the IPSec header is removed by the IPSec module, the message is passed on to the higher layers of the protocol stack without further modification.

The state of the IP header is restored because the IPSec module would drop the IP packet with altered IP header.

The second application scenario is related to network mobility whereby mobile routers are used to host communication devices. In this scenario, mobile routers intercommunicate wirelessly, for example, using wireless LAN in a nested network or ad hoc network. In these networks, the flat routing technique may be used. In the flat routing technique, all mobile routers are considered as equal, i.e., no subnet partitioning. An embodiment of the invention which is adapted to support this application scenario is described as follows.

Accordingly, in this application scenario, a message from a mobile network node may be routed through a multi-hop route via mobile routers, before it is finally routed to its destination on the Internet or on another mobile ad-hoc network. It should be noted that while being routed through a multi-hop route via mobile routers, the source and destination addresses of the message may be changed.

Therefore, in order to support this application scenario, after address swapping is performed, a replica of the message header is taken and added to the start of the message. This means that there are two copies of the message header in the message. The first message header is used by the routing technique (and may be modified accordingly) in order to deliver the message to its destination. At the receiving side, the first message header is discarded and subsequent processing (performing address swapping, etc.) is carried out as before using the second message header.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

In this document, the following publications are cited:
[1] J. Rosenberg. Session initiation protocol. RFC 3261, June 2002.
[2] D. Katz. IP router alert option. RFC 2113, February 1997.
[3] P. Ferguson and D. Senie. Network ingress filtering: Defeating denial of service attacks which employ IP source address spoofing. RFC 2267, January 1998.
[4] P. Vixie, S. Thomson, Y. Rekhter, and J. Bound. Dynamic updates in the domain name system (DNS UPDATE). RFC 2136, April 1997.

1-32. (canceled)

33. A method for transmitting data from a first communication device to a second communication device, comprising
generating a message, wherein the message comprises data to be transmitted to the second communication device and a destination address,
associating a first address of the second communication device as the destination address for the message,
determining a second address of the second communication device, wherein the determining of the second address of the second communication device comprises
determining the address of a network agent device where the second address of the second communication device is registered, and
sending an address request message to the network agent device using the address of the network agent device determined to request the second address of the second communication device,
mapping the first address of the second communication device to the second address of the second communication device as the destination address for the message, and
transmitting the message using the second address of the second communication device as the destination address for the message.

34. Method according to claim 33, wherein the mapping is carried out by using an address mapping table.

35. Method according to claim 34, wherein the address mapping table is stored in the first communication device.

36. Method according to claim 33, wherein the address request message is sent when it is determined that a communication connection to the second communication device could not be established using the first address of the second communication device or a third address of the second communication device stored on the first communication device.

37. Method according to claim 33, wherein the first address of the second communication device and the second address of the second communication device are addresses of the same protocol layer.

38. Method according to claim 37, wherein the first address of the second communication device and the second address of the second communication device are network layer addresses.

39. Method according to claim 38, wherein the first address of the second communication device and the second address of the second communication device are Internet Protocol (IP) addresses.

40. Method according to claim 33, wherein the first address of the second communication device is mapped to the second address of the second communication device by a unit of the network layer.

41. Method according to claim 33, wherein the message comprises the first address of the second communication device and the first address of the second communication device is mapped to the second address of the second communication device by deleting the first address of the second communication device from the message and inserting the second address of the second communication device into the message.

42. Method according to claim 34, wherein the address mapping table comprises a correspondence of the first address of the second communication device and the second address of the second communication device.

43. The method of claim 42, wherein the address mapping table further comprises an index to an information table, wherein the second address of the second communication device is stored in the information table according to the index.

44. The method of claim 33, wherein the address request message is sent according to a call control protocol.

45. The method of claim 44, wherein the call control protocol is SIP.

46. The method of claim 33, wherein the network agent device is a Session Initiation Protocol Redirect Server (SIP-RS).

47. The method of claim 46, wherein the address request message is an SIP Invite message.

48. The method of claim 47, wherein the address request message is an SIP Invite message with Binding Update option.

49. The method of claim 33, wherein the first communication device and the second communication device or both are radio communication devices.

50. The method of claim 49, wherein the first communication device and the second communication device or both are mobile radio communication devices.

51. The method of claim 50, wherein the first communication device and the second communication device or both are mobile phones, personal digital assistants or portable computers.

52. The method of claim 33, further comprising
encapsulating the message to generate an encapsulated message comprising the message by adding a header comprising the first address of the second communication device as destination address for the encapsulated message to the message
mapping the first address of the second communication device to the second address of the second communication device as destination address for the encapsulated message in the header.

53. A communication device, comprising
a message generating unit generating a message, wherein the message comprises data to be transmitted to another communication device and a destination address,
an associating unit associating a first address of the other communication device as the destination address for the message,
a determining unit determining a second address of the other communication device, wherein the determining of the second address of the other communication device comprises
determining the address of a network agent device where the second address of the other communication device is registered, and
sending an address request message to the network agent device using the address of the network agent device determined to request the second address of the other communication device,
a mapping unit mapping the first address of the other communication device to the second address of the other communication device as the destination address for the message, and
a transmission unit transmitting the message using the second address of the other communication device as the destination address for the message.

54. A method for transmitting data from a first communication device to a second communication device, comprising
generating a message, wherein the message comprises data to be transmitted to the second communication device and a source address,
associating a first address of the first communication device as the source address for the message,
determining a second address of the first communication device,
wherein the determining of the second address of the first communication device comprises storing the second address of the first communication device on a network agent device,
mapping the first address of the first communication device to the second address of the first communication device as the source address for the message, and
transmitting the message using the second address of the first communication device as the source address for the message.

55. The method according to claim 54, comprising
the first communication device requesting, by sending a registering message comprising the second address of the first communication device to the network agent device, that the second address of the first communication device is stored on the network agent device.

56. The method according to claim 54, wherein the second address of the first communication device is pre-stored on the network agent device.

57. A communication device, comprising
a message generating unit generating a message, wherein the message comprises data to be transmitted to another communication device and a source address,
an associating unit associating a first address of the communication device as the source address for the message,
a determining unit determining a second address of the communication device, wherein the determining of the second address of the communication device comprises storing the second address of the communication device on a network agent device,
a mapping unit mapping the first address of the communication device to the second address of the communication device as the source address for the message, and
a transmitting unit transmitting the message using the second address of the communication device as the source address for the message.

58. A method for receiving data transmitted from a first communication device to a second communication device, comprising
receiving a message, wherein the message comprises data transmitted to the second communication device and a first address of the second communication device as destination address,
determining a second address of the second communication device,
mapping the first address of the second communication device to the second address of the second communication device as the destination address for the message.

59. A communication device, comprising
a receiving unit receiving a message, wherein the message comprises data transmitted to the communication device and a first address of the communication device as destination address,
determining a second address of the communication device,
mapping the first address of the communication device to the second address of the communication device as the destination address for the message.

60. A method for receiving data transmitted from a first communication device to a second communication device, comprising
receiving a message, wherein the message comprises data transmitted to the second communication device and a first address of the first communication device as source address,
determining a second address of the first communication device,
mapping the first address of the first communication device to the second address of the first communication device as the source address for the message.

61. A communication device, comprising
a receiving unit receiving a message, wherein the message comprises data transmitted to the communication device and a first address of another communication device as source address,
determining a second address of the other communication device,
mapping the first address of the other communication device to the second address of the other communication device as the source address for the message.

62. A method for transmitting data from a first communication device to a second communication device, comprising
generating a message,
wherein the message comprises data to be transmitted to the second communication device, a source address and a destination address,
associating a first address of the first communication device as the source address for the message,
associating a first address of the second communication device as the destination address for the message,
determining a second address of the first communication device, wherein the determining of the second address of the first communication device comprises storing the second address of the first communication device on a network agent device, determining a second address of the second communication device, wherein the determining of the second address of the second communication device comprises
determining the address of another network agent device where the second address of the second communication device is registered, and
sending an address request message to the other network agent device using the address of the network agent device determined to request the second address of the second communication device,
mapping the first address of the first communication device with the second address of the first communication device as the source address for the message,
mapping the first address of the second communication device with the second address, of the second communication device as the destination address for the message, and
transmitting the message using the second address of the first communication device as the source address and the second address of the second communication device as the destination address for the message.
